(19) United States
(12) Patent Application Publication
(10) Pub. No.: US 2008/0221870 A1
(43) Pub. Date: Sep. 11, 2008

(54) System and method for revising natural language parse trees

(75) Inventors: Giuseppe Attardi, Pisa (IT); Massimiliano Ciaramita, Barcelona (ES)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/716,518

(22) Filed: Mar. 8, 2007

(51) Int. Cl. G06F 17/27

(52) U.S. Cl. 704/9

(57) ABSTRACT

An improved system and method for revising natural language parse trees is provided. A revision dependency parser may learn a set of transformation rules that may be applied to dependency parse trees generated by a base parser for revising the dependency parse trees. A corpus of natural language sentences and a set of correct dependency parse trees may be used to train a revision dependency parser to correct dependency parse trees generated by the base parser. A revision engine may compare the dependency parse trees produced by the base parser with the correct ones present in the training data to produce an observation-rule pair for each dependency. A rule may specify a transformation on the predicted dependency parse tree generated by the base parser to replace an incorrect dependency with a corrected dependency or may change the type of dependency expressed for the grammatical function of the dependent word.

### FIELD OF THE INVENTION

The invention relates generally to computer systems, and more particularly to an improved system and method for revising natural language dependency parse trees.

### BACKGROUND OF THE INVENTION

Many potential applications in the area of document search, knowledge management, and text mining require the ability to analyze documents written in natural language. Extracting accurate information from natural language sources requires natural language processing (NLP) techniques such as sentence parsing. From a news story's title, for example, such as “Company A sues Company B over technology patent”, a natural language parser may detect that “Company A” is the subject of a suing action, while “Company B” is the object of the action. Furthermore, the natural language parser may detect that the action is relative to a “technology patent”.

Traditional natural language parsing techniques have so far not been adequate enough for deployment in large scale applications such as those of interest to search engines and other web-based services that may require processing several hundreds of documents per second, handling several languages, adapting to multiple topic domains, and identifying relevant syntactic relations with adequate accuracy. Large scale applications require an accurate and scalable method for parsing textual content of natural language documents accessible on the web. Such a system and method must be able of coping with several natural languages and must adapt to deal with documents from different topic domains.

### SUMMARY OF THE INVENTION

The present invention provides a system and method for revising natural language dependency parse trees and improving the accuracy of a base parser. To do so, a natural language parser may be provided for generating natural language dependency trees, and a revision dependency parser may be provided for revising such generated natural language dependency trees by applying a learned set of transformation rules to them. In an embodiment, a revision dependency parser may include an operably coupled revision engine capable of learning transformation rules which specify transformations for correcting natural language dependency parse trees and capable of applying such transformations for correcting incorrect parse trees. Natural languages sentences may be received and a dependency parse tree may be generated for each natural language sentence by a base parser. Learned transformation rules may then by applied by a revision dependency parser to generate corrected dependency trees replacing the incorrect dependency trees generated by the base parser.

To learn a set of transformation rules that may be applied to a dependency parse tree for generating a corrected dependency tree, a set of sentences of a natural language may be received as well as the dependency trees generated by a base parser for each sentence in the set of sentences. Additionally, a set of correct dependency trees may also be received for the set of sentences. For instance, the set of correct dependency parse trees may be part of an annotated corpus including the set of sentences and, furthermore, may have been used to train the base parser in generating dependency parse trees. In any event, a set of transformation rules may be learned for correcting an incorrect dependency parse tree generated by the base parser, by comparing the dependency parse trees produced by the base parser with the correct ones present in the training data. The revision engine may compare the correct dependency parse tree and the predicted dependency parse tree generated by the base parser and may produce an observation-rule pair for each dependency in the parse tree. The rule may specify a transformation on the predicted dependency tree generated by the base parser to replace the incorrect dependency with the correct one. Additionally, a transformation rule may identify the correct type of dependency expressing the grammatical function of the dependent word.

The present invention may support many applications for analyzing text written in natural language. For example, online search applications that may access text or documents from multiple sources may use the present invention to parse sentences for semantic analysis. The present invention has the advantage that it may allow adapting the parser to handle variants or specializations of the language on which the base parser was trained, and, therefore, may allow adapting the base parser without requiring any additional data or resources other than those needed for training the base parser. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for revising natural language parse trees, in accordance with an aspect of the present invention;

FIGS. 3A and 3B present illustrations depicting dependency parse trees in an embodiment, in accordance with an aspect of the present invention;

FIG. 4 is a flowchart generally representing the steps undertaken in one embodiment for revising natural language parse trees, in accordance with an aspect of the present invention; and

FIG. 5 is a flowchart generally representing the steps undertaken in one embodiment for learning a set of transformations that may be applied to a dependency parse tree for generating a corrected dependency parse tree, in accordance with an aspect of the present invention.

### DETAILED DESCRIPTION

### Exemplary Operating Environment

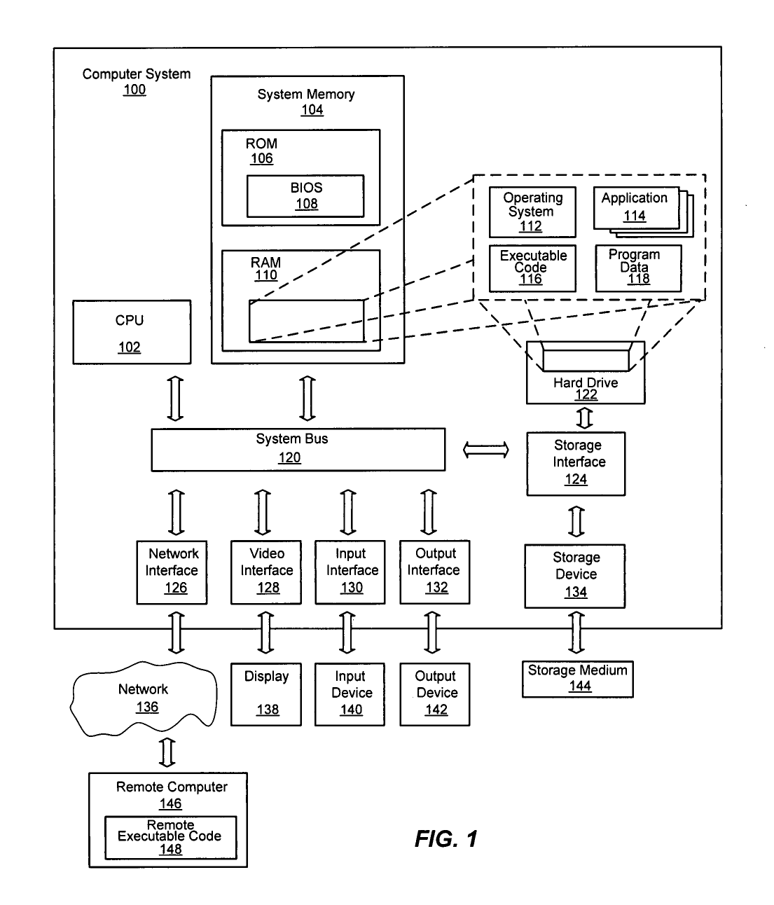

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Revising Natural Language Parse Trees

The present invention is generally directed towards a system and method for revising natural language parse trees. A revision dependency parser may learn a set of transformation rules that may be applied to a dependency parse tree generated by a base parser for revising the dependency parse tree. A corpus of natural language sentences and a set of correct dependency parse trees may be used to train a revision dependency parser to correct dependency parse trees generated by the base parser. A revision engine may compare the dependency parse trees produced by the base parser with the correct ones present in the training data to produce an observation-rule pair for each dependency. A rule may specify a transformation on the predicted dependency parse tree generated by the base parser to replace an incorrect dependency with a correct one.

As will be seen, the framework described may support many applications for analyzing text written in natural language. For example, online search applications that may access text or documents from multiple sources may use the present invention to parse sentences for semantic analysis. As will be understood, the various block diagrams, flow charts and scenarios described herein are only examples, and there are many other scenarios to which the present invention will apply.

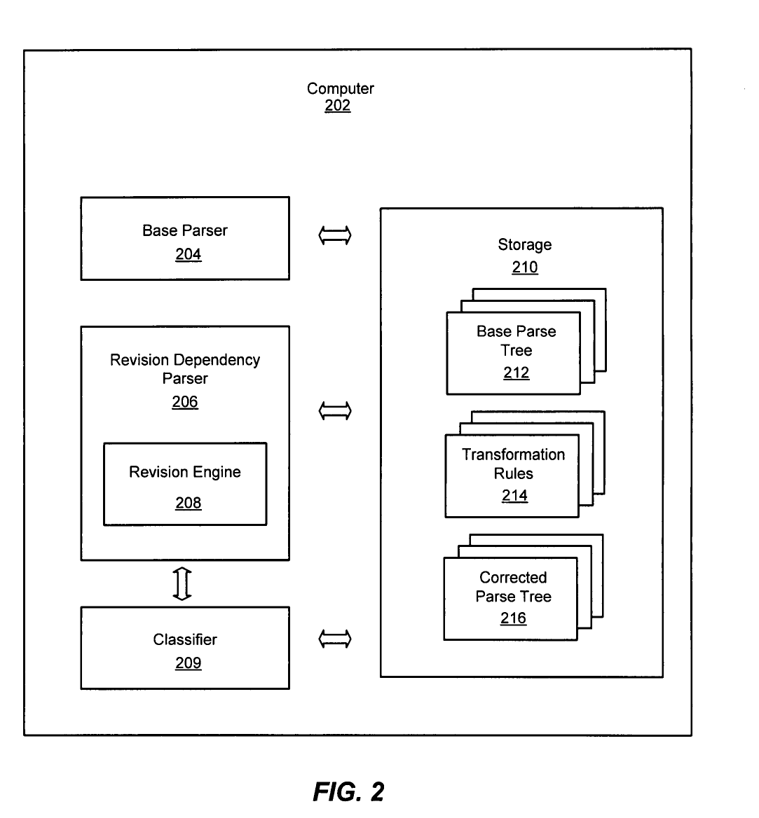

Turning to FIG. 2 of the drawings, there is shown a block diagram generally representing an exemplary architecture of system components for revising natural language parse trees. Those skilled in the art will appreciate that the functionality implemented within the blocks illustrated in the diagram may be implemented as separate components or the functionality of several or all of the blocks may be implemented within a single component. For example, the functionality for the classifier 209 may be implemented as a component within the revision dependency parser 206. Or the functionality of the base parser 204 may be implemented on another computer as a separate component from the computer 202. Moreover, those skilled in the art will appreciate that the functionality implemented within the blocks illustrated in the diagram may be executed on a single computer or distributed across a plurality of computers for execution.

In various embodiments, a computer 202, such as computer system 100 of FIG. 1, may include a base parser 204 and a revision dependency parser 206.operably coupled to storage 210. In general, the base parser 204 and the revision dependency parser 208 may be any type of executable software code such as a kernel component, an application program, a linked library, an object with methods, and so forth. The storage 210 may be any type of computer-readable media and may store dependency parse trees 212 generated by the base parser 204, transformation rules 214 generated by the revision engine 208, and corrected dependency parse trees 216 generated by the revision dependency parser 206. A transformation rule 214 may represent an observation-rule pair where the observation may include features of the dependency and its surrounding context, and the rule may specify a transformation on the dependency parse tree for replacing an incorrect dependency with a correct dependency.

The base parser 204 may apply natural language processing techniques, including sentence parsing, for generating a dependency parse tree for a sentence of a natural language. In various embodiments, a base parser may generate dependency parse trees for sentences of different natural languages. In various other embodiments, there may be several base parsers, one for each different natural language. The revision dependency parser 206 may apply a set of learned transformation rules 214 to base dependency parse trees 212 generated by the base parser 204 to generate corrected dependency parse trees 216 for the sentences. The revision dependency parser 206 may be operably coupled to a revision engine 208 that may learn a set of transformation rules to apply for revising an incorrect dependency parse tree. In an embodiment, the revision engine may train a classifier 209 for choosing which transformation rule to apply to each identified class of dependency parse trees. The revision engine 208 may also be any type of executable software code such as a kernel component, an application program, a linked library, an object with methods, or other type of executable software code.

There are many applications which may use the present invention for analyzing text written in natural language. For example, online search applications that may access text or documents from multiple sources may use the present invention to parse sentences for semantic analysis. For instance, a biologist might want to use an online application to search the existing vast collections of scientific biomedical literature (such as Medline, SwissProt, etc.) to identify, or even discover, interactions between genes and proteins. Or a financial analyst may use an online application to examine several news sources in order to extract facts or events that may have financial relevance and may wish to track companies in the news through automatic news feed such as those provided by Yahoo! Finance. In particular, a financial analyst determining a rating for a company might be interested in knowing whether there may be any pending charges or claims brought against that company. For any of these applications, text or documents written in natural languages may be parsed for mining syntactic relationships accurately.

Dependency parsing is a parsing technique that may be suitable for large scale applications like web mining applications. Dependency parsers can be implemented efficiently, do not require a grammar for the language, and hence can be ported with minimal effort to several languages. A statistical dependency parser can be trained on a corpus of annotated sentences, which may be more easily created than a corpus of full constituent parse trees. Several such corpora, for multiple languages, are available for this purpose.

The task of a dependency parser is to reconstruct the dependency parse tree of a natural language sentence. As used herein, a dependency parse tree may mean a directed acyclic graph having a word of a sentence as the root node of the directed graph and the remaining words of the sentence as an ancestor node of the root node. Thus, one word of a sentence may be the head of a sentence in a dependency parse tree, and all other words may be either a dependent of that head word or else a dependent on some other word of the sentence. A dependency relates a word to a dependent word and has an associated type, expressing the grammatical function of the dependency, including for example subject, object, predicate, determiner, modifier and so forth.

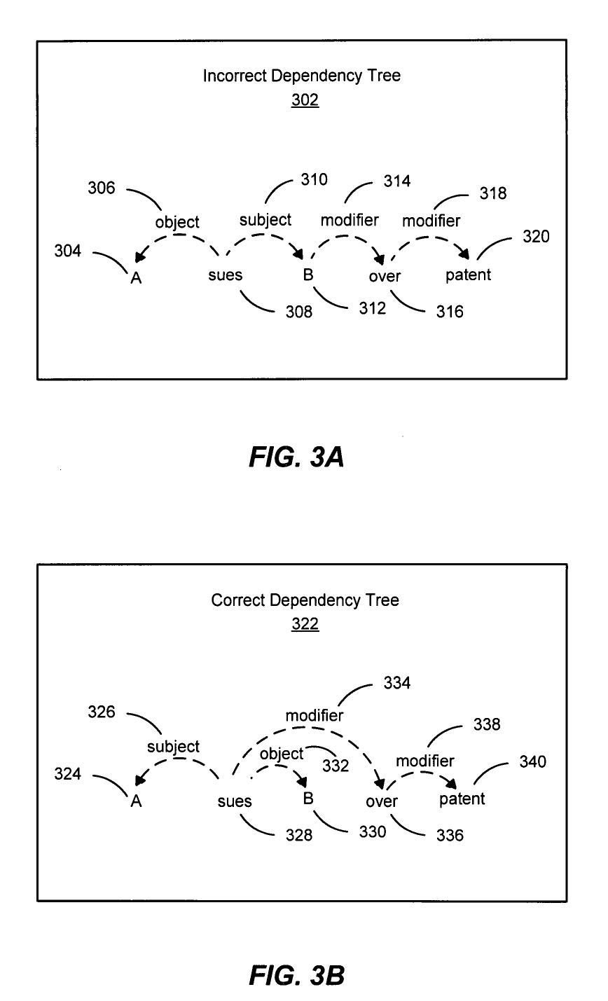

FIGS. 3A and 3B present illustrations depicting dependency parse trees in an embodiment. In particular, FIG. 3A shows an incorrect dependency parse tree 302 for the following sentence: “A sues B over patent.” The head word of the dependency parse tree is “sues” 308 from which the word “A” 304 is illustrated as dependent with type “object” 306 and from which the word “B” 312 is illustrated as dependent with type “subject” 310. The word “over” 316 is illustrated as dependent from the word “B” 312 with type “modifier” 314 and the word “patent” 320 is in turn illustrated as dependent from the word “over” 316 with type “modifier” 318.

Dependency parse tree 302 may be incorrect for several reasons. First of all, the word “A” 304 should be assigned type “subject” rather than type “object” 306. Second, the word “B” should be assigned type “object” instead of type “subject” 310. Third, the word “over” 316 should be illustrated as dependent from the word “sues” 308 rather than illustrated as dependent from the word “B” 312. FIG. 3B shows a correct dependency parse tree 322 for the sentence: “A sues B over patent.” The head word of the dependency parse tree is “sues” 328 from which the word “A” 324 is illustrated as dependent with the correct type “subject” 326 and from which the word “B” 330 is illustrated as dependent with the correct type “object” 332. The word “over” 336 is now illustrated as dependent from the word “sues” 328 with type “modifier” 334 and the word “patent” 340 is in turn illustrated as dependent from the word “over” 336 with type “modifier” 338. Importantly, relevant relations concerning the “suing” action may be easily extracted from the dependency parse tree by applications mining syntactic relationships.

A set of transformation rules may specify transformations on the dependency parse tree for replacing an incorrect dependency with a correct dependency. For instance, there may be two kinds of transformation rules, those that modify a link between dependencies in the tree, and those that may modify labels describing the grammatical function of dependencies. A label transformation rule may specify the replacement of one label with another, such as “OBJ->SUBJ”, which may specify a change of the dependency label from “object” to “subject”. Application of this label transformation rule to the link dependency 306 in FIG. 3A may result in the label for link dependency 326 in FIG. 3B. Similarly, application of a label transformation rule that may specify a change of the dependency label from “object” to “subject”, such as “SUBJ→OBJ”, to the link dependency 310 in FIG. 3A may result in the label for link dependency 332 in FIG. 3B.

The link transformation rules may provide elementary movement of a link dependency along the nodes of a tree. Examples of possible elementary movements of a link dependency among nodes of a tree may be move down left, move down right, move up to the root, move to the next token on the right, move to the previous token on the left, and so forth. Additional compound rules may be made as combinations of elementary movements, like move up twice and then down to the left, or move up and then one to the right. Such link transformation rules may be applied to replace an incorrect dependency with a correct dependency. As discussed in conjunction with FIGS. 3A and 3B above, a link transformation rule may be applied to move the link dependency 314 in FIG. 3A to produce the link dependency 334 in FIG. 3B. In specific, a link transformation rule may be applied which may specify an elementary movement to move the link dependency up a node in the tree. Several rules may apply to correct a single dependency. For example, a link transformation rule may also be applied which may specify an elementary movement to move the link dependency for the node to the root node to also move the link dependency 314 in FIG. 3A to produce the link dependency 334 in FIG. 3B. Generally, the task of the revision engine may be to select an appropriate rule for each node, typically giving preference to the shorter rules. In practice, most errors can be corrected with a small number of rules. While the rules may be applied to each node independently from each other, application of the rules might be chosen in an embodiment according to a global heuristic.

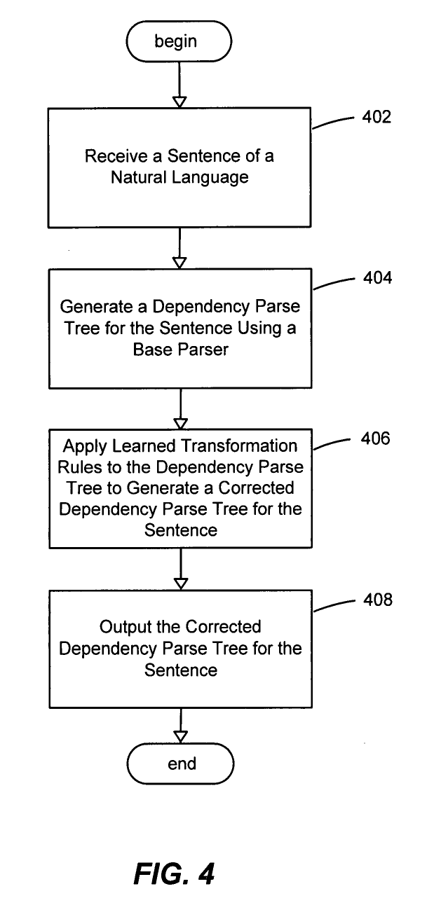

FIG. 4 presents a flowchart generally representing the steps undertaken in one embodiment for revising natural language parse trees. At step 402, a sentence of a natural language may be received. In an embodiment, the sentence of the natural language may be obtained from a corpus of annotated sentences. A dependency parse tree may then be generated at step 404 for the sentence using a base parser. In an embodiment, the base parser may be a dependency parser and may generate a type associated with each word of the dependency parse tree that may express the grammatical function of the dependency.

Once a dependency parse tree may be generated for the sentence using a base parser, learned transformation rules may be applied to the dependency parse tree at step 406 to generate a corrected dependency parse tree. The corrected dependency parse tree may be output at step 408 for the sentence and processing may be finished for revising natural language parse trees. For example, the corrected dependency parse tree may be stored for use by applications mining syntactic relationships.

In an embodiment, a revision dependency parser may learn the transformation rules by training a revision classifier on the same data used to train the base dependency parser, and then the revision dependency parser may apply the learned transformation rules to the dependency parse tree to generate a corrected dependency parse tree. Each transformation rules may represent an observation-rule pair where the observation may include features of the dependency and its surrounding context, and the rule may specify a transformation on the dependency parse tree for replacing an incorrect dependency with a correct dependency.

The transformation rules may generally revise a dependency parse tree either by attaching a dependent word to a different word in the sentence or by changing the type of dependency expressing the grammatical function of the dependent word. Referring back to incorrect dependency parse tree 302 for example, the word “over” was detached as dependent from the word “B” and attached as dependent from the word “sues”. Furthermore, the assigned type “object” was changed to the type “subject” for the word “A”, and the assigned type “subject” was changed to the type “object” for the word “B”.

In general, a sentence may be scanned from left to right and each word may be analyzed only once in an embodiment. Each word's dependency may be analyzed by a multi-class classifier in which each class corresponds to a revision rule, including a special rule to handle the case where no correction is needed. If the dependency is judged to be correct it is left unchanged, otherwise a revision rule is chosen to correct the mistake. Thus, the computational cost of the process may be linear.

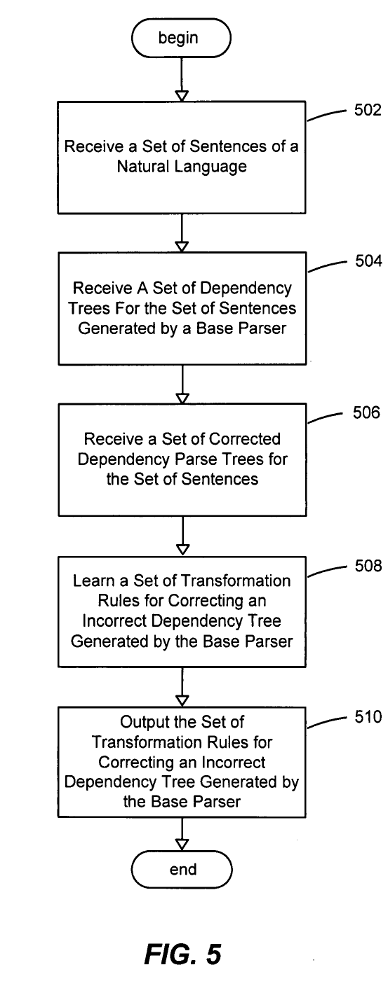

FIG. 5 presents a flowchart generally representing the steps undertaken in one embodiment for learning a set of transformations that may be applied to a dependency parse tree for generating a corrected dependency parse tree. At step 502, a set of sentences of a natural language may be received. In an embodiment, a set of sentences may be used from a commercially available training corpus. A set of dependency parse trees generated by a base parser may also be received at step 504 for each sentence in the set of sentences. And a set of corrected dependency parse trees may be received at step 506 for the set of sentences. In an embodiment, the set of corrected dependency parse trees may represent corrected dependency parse trees for a subset of the set of sentences.

At step 508, a set of transformation rules may be learned for correcting an incorrect dependency parse tree generated by the base parser. A revision dependency parser may learn the transformation rules in an embodiment by training a revision classifier on the same data used to train the base dependency parser. For instance, a revision dependency parser may employ a revision engine to compare the dependency parse trees produced by the base parser with the correct ones present in the training data. By comparing the correct dependency parse tree and the predicted dependency parse tree generated by the base parser, the revision engine may produce an observation-rule pair for each dependency. The observation may be represented in terms of features of the dependency and its surrounding context. The rule may specify a transformation on the predicted dependency parse tree generated by the base parser to replace the incorrect dependency with the correct one. A transformation rule may identify the correct word from which another word of the sentence may depend as a sequence of basic movements on the predicted dependency parse tree. For example, a sequence of movements may be to go up or down one node or to move n positions to the left or right in the linear ordering of the sentence. Additionally, a transformation rule may identify the correct attribute for a dependent word and may change the type of dependency expressed for the grammatical function of the dependent word. In various embodiments, a special rule may be used for correct dependencies which require no transformation or movement.

Thus the transformation rules for revising a dependency parse tree need not be pre-defined but may be generated from the training data itself by comparing the corrected dependency parse trees with those predicted by the base parser. Once the observation-rule pairs may have been collected from the analysis of the training data, a classifier may be trained on these observation-rule pairs in an embodiment. Given an observation of a dependency and its context, the classifier may accordingly learn to predict the appropriate revision rule to apply. Any classifier can be used for this purpose.

At step 510, the set of transformation rules for correcting an incorrect dependency parse tree generated by the base parser may be output and processing may be finished for learning a set of transformations that may be applied to a dependency parse tree for generating a corrected dependency parse tree.

Thus the present invention may flexibly improve both the speed and accuracy of dependency parsing by providing a simple and more scalable method for parsing natural language sentences. A dependency parse tree for any natural language sentence produced by an arbitrary dependency parser may be corrected by a learned set of transformation rules. Advantageously, the method is very efficient and maintains the complexity of whatever method may be implemented in the base parser. Moreover, the system and method may allow adapting the parser to handle variants or specializations of the language on which the base parser was trained, and, therefore, may improve the portability of the base parser without requiring any additional data or resources other than those needed for training the base parser.

As can be seen from the foregoing detailed description, the present invention provides an improved system and method for revising natural language parse trees. Text written in a variety of natural languages may have natural language parse trees generated by one or more base parsers, and incorrect parse trees may be revised by a revision dependency parser. Such a system and method may support large scale applications providing web-based services, such as search engines, and may adapt to multiple topic domains. Moreover, the techniques of the present invention could be extended to other structured learning problems, not necessarily involving language processing tasks. In particular, the techniques of the present invention may be applied to any tasks whose goal is to produce trees, for instance generating the skeleton of an image, producing a tree-structure partition for fractal image compression, generating phylogenetics trees for genomics data (phylogenomics) or in gene expression. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for revising natural language parse trees, comprising:
a revision dependency parser for revising natural language dependency parse trees by applying a learned set of transformation rules to the natural language parse trees; and
a storage operably coupled to the revision dependency parser for storing the learned set of transformation rules, each transformation rule specifying a transformation on a natural language dependency parse tree for replacing an incorrect dependency of a word of a natural language sentence with a correct dependency of the word of the natural language sentence.

2. The system of claim 1 further comprising a revision engine operably coupled to the revision dependency parser for learning each transformation rule specifying the transformation on the natural language dependency parse tree.

3. The system of claim 1 further comprising a revision engine operably coupled to the revision dependency parser for applying transformation rules in order to correct incorrect natural language dependency parse trees.

4. The system of claim 1 further comprising a natural language parser operably coupled to the revision dependency parser for generating the natural language dependency parse trees.

5. A computer-readable medium having computer-executable components comprising the system of claim 1.

6. A computer-implemented method for revising natural language parse trees, comprising:
receiving a sentence of a natural language;
generating a dependency parse tree for the sentence using a base parser;
applying learned transformation rules to the dependency parse tree to generate a corrected dependency parse tree; and
outputting the corrected dependency parse tree for the sentence.

7. The method of claim 6 wherein generating a dependency parse tree for the sentence using a base parser comprises generating a type expressing a grammatical function of the dependency of a word in the dependency parse tree.

8. The method of claim 6 wherein applying learned transformation rules to the dependency parse tree to generate a corrected dependency parse tree comprises attaching a dependent word to a different word in the dependency parse tree.

9. The method of claim 6 wherein applying learned transformation rules to the dependency parse tree to generate a corrected dependency parse tree comprises changing a type expressing a grammatical function of the dependency of a word in the dependency parse tree.

10. The method of claim 6 wherein applying learned transformation rules to the dependency parse tree to generate a corrected dependency parse tree comprises applying a rule for recognizing a correct dependency parse tree without changing the correct dependency parse tree.

11. The method of claim 6 wherein outputting the corrected dependency parse tree for the sentence comprises storing the corrected dependency parse tree in storage.

12. The method of claim 6 further comprising learning the transformation rules to apply to the dependency parse tree to generate the corrected dependency parse tree.

13. The method of claim 12 wherein learning the transformation rules to apply to the dependency parse tree to generate the corrected dependency parse tree comprises receiving a set of sentences of the natural language and set of correct dependency parse trees.

14. The method of claim 13 further comprising receiving a set of dependency parse trees generated by the base parser for the set of sentences of the natural language.

15. The method of claim 14 further comprising comparing the set of correct dependency parse trees and the set of dependency parse trees generated by the base parser.

16. The method of claim 15 further comprising learning a rule to attach a dependent word to a different word in the dependency parse tree for a class of dependency parse trees.

17. The method of claim 15 further comprising learning a rule to change a type expressing a grammatical function of the dependency of a word in the dependency parse tree.

18. The A computer-readable medium having computer-executable instructions for performing the method of claim 6.

19. A computer-implemented method for learning how to revise natural language parse trees, comprising:
receiving a set of sentences of a natural language;
receiving a set of correct dependency parse trees for the set of sentences of the natural language;
receiving a set of dependency parse trees generated by a base parser;
generating a set of observation-rule pairs for correcting a plurality dependency parse trees of the set of dependency parse trees generated by the base parser;
training a classifier using the set of observation-rule pairs to generate a set of transformation rules and a learned model for applying transformation rules; and
outputting the set of transformation rules and the learned model for applying transformation rules.

20. A computer system for revising a natural language parse tree, comprising:
means for generating a dependency parse tree for a sentence of a natural language;
means for applying learned transformation rules to the dependency parse tree to generate a corrected dependency parse tree; and
means for outputting the corrected dependency parse tree for the sentence.

21. The computer system of claim 20 further comprising means for learning the transformation rules to apply to the dependency parse tree to generate the corrected dependency parse tree.

22. The computer system of claim 21 wherein means for learning the transformation rules to apply to the dependency parse tree to generate the corrected dependency parse tree comprises means for comparing a correct dependency parse tree and the generated dependency parse tree.
